(19) United States
(12) Patent Application Publication
(10) Pub. No.: US 2008/0135157 A1
(43) Pub. Date: Jun. 12, 2008

(54) Manufacture of Reinforced Tubular Products of Predetermined Length

(76) Inventor: William James Donnelly, Heidelberg (AU)

Correspondence Address: Greer Burns Crain LTD, 300 South Wacker Drive, Suite 2500, Chicago, IL, 60606, US

(21) Appl. No.: 11/579,172

(22) PCT Filed: Apr. 29, 2005
(86) PCT No.: PCT/AU05/00621

§ 371 Date: Dec. 10, 2007

(30) Foreign Application Priority Data
Apr. 30, 2004 (AU) 2004902300

(51) Int. Cl. B29C 53/58; B65H 81/08

(52) U.S. Cl. 156/143; 156/392

(57) ABSTRACT

An apparatus for manufacturing a tubular product, includes a winding station for winding a substrate component and a reinforcement element in a helical path to form a reinforced tubular product, and respective apparatus for feeding the elongate substrate component and the elongate reinforcement element to the winding station. A first severing device cuts the reinforcement element upstream of the winding station, whereupon delivery of the reinforcement element upstream of the cut is withheld for a predetermined time period that results in a segment of the tubular product without the reinforcement element. A second severing device severs the tubular product within the above said segment to provide the predetermined length of the tubular product.

### FIELD OF THE INVENTION

This invention relates generally to the manufacture of ducting and other tubular products where a continuously fed flexible component having an associated reinforcement element is helically wound to form the product. The invention is concerned in particular with cutting predetermined lengths of the tubular product, and has particular utility in the manufacture of ducting for heating and air conditioning systems.

### BACKGROUND OF THE INVENTION

For a number of years, flexible ducting for heating and air conditioning systems has been manufactured by helically laminating a polymer strip material with a wire reinforcement to form a tube. The wire reinforcement ensures roundness integrity, and the tube is substantially non-insulating. Thermal insulation is provided by a soft blanket made from fibreglass or polymer based fibre, wrapped about the tube and secured with an outer sheath of polymer film or aluminium tube material. The insulation blanket and the securing outer sheath are generally applied manually as a secondary manufacturing process, with the aid of appropriate jigs and fixtures.

This style of ducting is still predominant. However, with the increasing load of air conditioning systems on electricity supply grids, and a general desire for more thermally efficient systems, there has been a need to develop ducting with improved thermal protection.

To address this need, Australian patent 773565 discloses a flexible tubular duct that comprises a strip of flexible substrate material with a rounded portion that encapsulates a solid core of insulating material and is helically wound to form the tubular duct. The core is cylindrical in shape and is a sliver or continuous length of insulation material. The tubular duct also includes a helically wound reinforcement element which is encapsulated by the strip of substrate material in the tubular duct.

The duct construction of patent 773565 exhibits good thermal insulation properties, and can be efficiently formed with its insulation in a single automatic manufacturing operation.

Generally within the field of manufacturing flexible duct, it is the practice for the production machine to be stopped, or slowed considerably, to sever the duct at a selected length, and to effect this severance manually. The historical reasons for this, despite automatic cut-off devices being devised for a plethora of other tube styles and for similar products, is that the raw materials involved in flexible duct production are quite diverse and require diverse physical forces to effect severance, particularly when formed as a tube.

The reinforcing wire, generally being of a thickness and hardness, eg. spring-grade, requiring considerable guillotine force to effect severance, responds poorly to mechanical intervention when set between the laminations of polymer material and adhesives. The difficulty of severance is further compounded by the pliability of the substrate material and by the generally hollow tube forms involved.

Those skilled in the art of constructing flexible duct production machines have unsuccessfully invested considerable labour and funding into research in attempts to automatically sever duct to predetermined lengths.

It is an object of this invention to at least partially resolve this problem in duct manufacture, ie. to achieve automatic severance of the duct to predetermined lengths without manual intervention, and preferably to do so substantially without interrupting or slowing the helical winding process.

### SUMMARY OF THE INVENTION

The invention essentially involves the realisation that the severance problem can be met by addressing the complexity of the cutting operation arising from the range of materials present, and in particular by severing a predetermined length of the tubular product by cutting one component and withholding delivery of that component for a predetermined time period that results in a segment of the tubular product without the component, and then severing the tubular product within the segment to provide the predetermined length of the tubular product.

The invention accordingly provides a method of manufacturing a reinforced tubular product, including the steps of:
feeding an elongate substrate component and an elongate reinforcement element to a winding station,
winding the substrate component and the reinforcement element at the winding station in a helical path to form a reinforced tubular product; and
severing a predetermined length of the tubular product by cutting the reinforcement element upstream of the winding station and withholding delivery of the reinforcement element upstream of the cut for a predetermined time period that results in a segment of the tubular product without the reinforcement element, and then severing the tubular product within said segment whereby to provide said predetermined length of the tubular product.

The invention further provides apparatus for manufacturing a tubular product, including:
a winding station for winding a substrate component and a reinforcement element in a helical path to form a reinforced tubular product;
respective means for feeding said elongate substrate component and said elongate reinforcement element to said winding station;
first severing means to cut the reinforcement element upstream of the winding station;
means to withhold delivery of the reinforcement element upstream of the cut for a predetermined time period that results in a segment of the tubular product without the reinforcement element; and
second severing means to sever the tubular product within said segment to provide said predetermined length of the tubular product.

The apparatus preferably further includes control means for activating said first severing means and said withholding means so as to cut the reinforcement element upstream of the winding station and withhold delivery of the reinforcement element upstream of the cut for a predetermined time period that results in the segment of the tubular product without the reinforcement element, said control means then activating said second severing means to sever the tubular product within said segment whereby to provide said predetermined length of the tubular product.

In an advantageous application, the tubular product is a duct.

For example, said elongate substrate component is a strip of flexible substrate material that in the duct forms a helically wound rounded portion that encapsulates a solid core of insulating material and wherein the helically wound reinforcement element is encapsulated by the strip of flexible substrate material in the tubular duct.

The first severing means may conveniently comprise a wire guillotine, preferably mounted for sliding movement parallel to the wire, and may include housing means to absorb the reaction force of the wire severance. The second severing means may comprise, eg., a knife device or a high temperature cutting device that severs the duct by melting or evaporation of the substrate component in an annular zone of the duct, within said segment.

Typically, the reinforcement element is wire, eg. metal wire. Preferably, said time period is the time for the winding station to form four to eight windings.

### BRIEF DESCRIPTION OF THE DRAWINGS

The present invention will now be further described, by way of example only, with reference to the accompanying drawings, in which:

FIG. 1 is an isometric diagram of apparatus for forming a flexible tubular duct in accordance with a preferred embodiment of the invention, including detail of the winding mandrel and the mechanism for severing predetermined lengths of duct;

FIG. 2 is a fragmentary cross-sectional diagram showing three successive windings in a duct formed with the apparatus of FIG. 1;

FIG. 3 is an isometric view of the wire severance and withholding mechanism;

FIG. 4 is a plan view of the duct severing mechanism; and

FIG. 5 is a fragmentary cross-sectional diagram on the line 5-5 in FIG. 4.

### EMBODIMENTS OF THE INVENTION

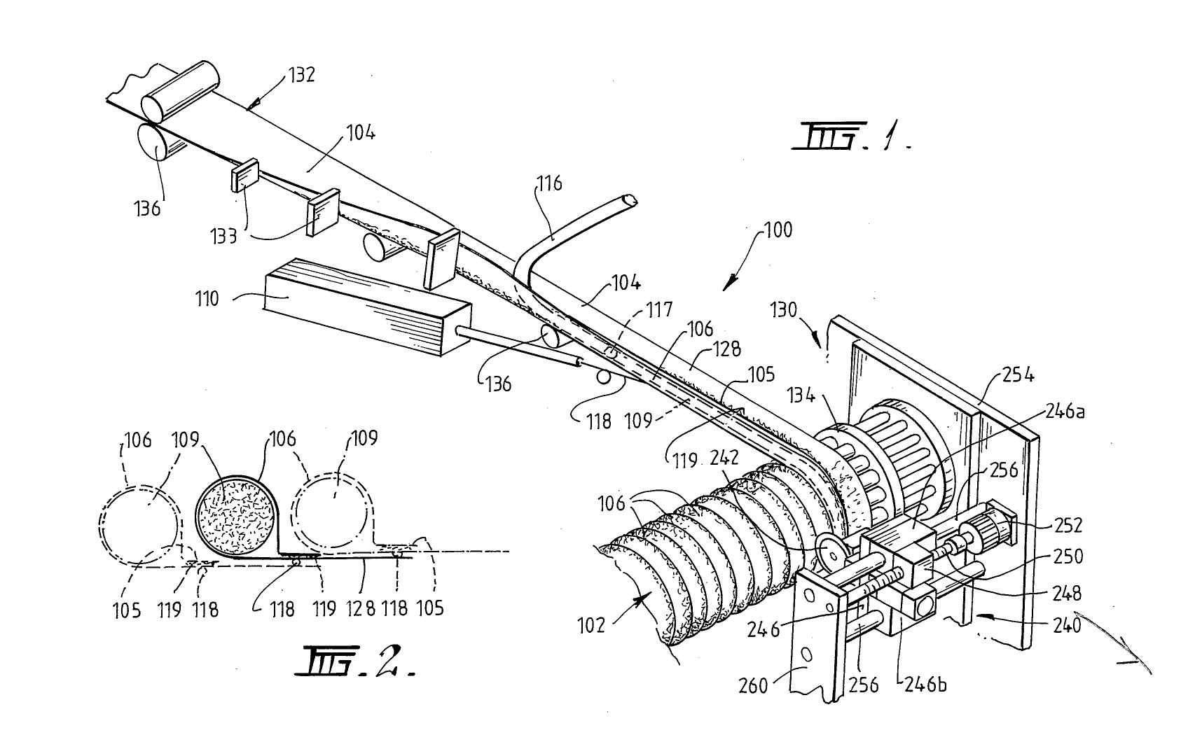

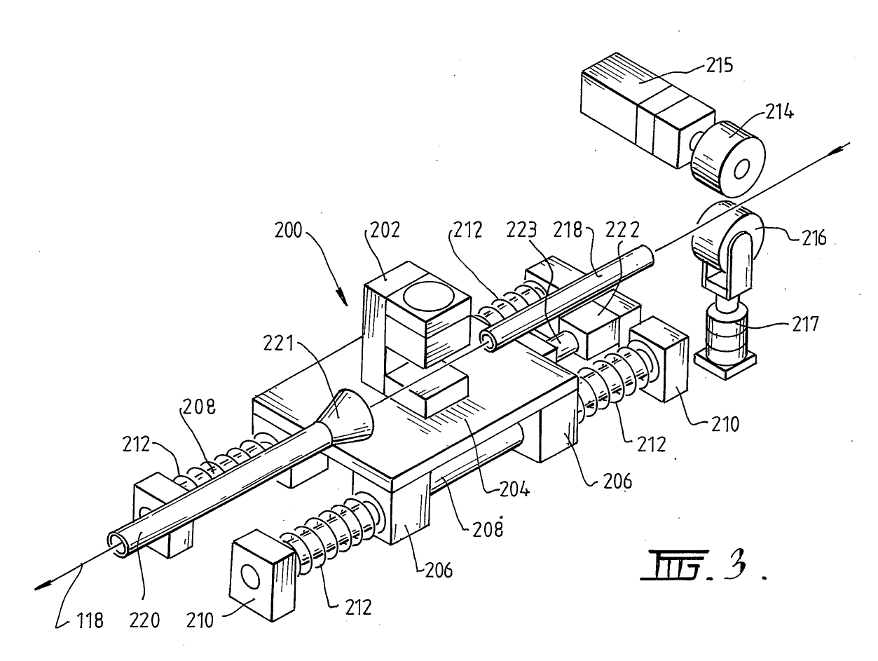

FIG. 1 shows an apparatus 100 for manufacturing flexible tubular duct 102 in accordance with an embodiment of the invention. Apparatus 100 includes a winding station 130 having a mandrel 134 to which a strip 104 of flexible substrate material is fed, from a reel or other supply of the material, and helically wound, in a manner to be described, to form flexible tubular duct 102. Substrate feeding means 132 for feeding strip 104 to mandrel 134 comprises suitable guide structure depicted in FIG. 1 purely by representative diagram elements 136. Structure 136 also carries means 133 for bending the strip 104 to form a rounded encapsulating portion 106 of initial cross-section determined by a delivery tube 116 about which the strip is wrapped.

A core cavity is defined by delivery tube 116, downstream from the mouth 117 of the tube. A suitable insulating material is continuously fed via delivery tube 116 to form an insulating core 109 encapsulated by rounded portion 106 of strip 104. Rounded portion 106 is formed by only part of the width of strip 104: the balance remains substantially flat and defines a tail portion 128, so that the strip assumes the appearance of a P-shape in cross-section. The folded-over rounded portion 106 terminates at an edge lip 105 that folds out flat onto tail portion 128.

The third principal component of the duct is an elongate reinforcement element in the guise of a wire 118 that is delivered, by means 110 including suitable wire guides, against and under tail portion 128, so as to lie parallel to strip 104 and rounded portion 106.

The assembly of strip 105, wire 118 and rounded portion 106 encapsulating insulating core 109, is wound up helically on mandrel 134 so that successive windings abut and combine to form flexible duct 102. Duct 102 is formed such that the helix spacing is less than the external diameter of the core 109. The duct has somewhat of the appearance of a lobster tail. The rounded encapsulating portion 106 of each successive winding overlies and abuts the tail portion 128 of the previous winding, and wire 118 is encapsulated between these two successive tail portions. An adhesive film 119 applied to the strip 104 by a suitable applicator, ensures that the edge lip 105 of the rounded encapsulating portion is adhered to its own tail portion at adhesive film 119, and that the rounded portion of the next winding is adhered to that tail portion. The successive windings might alternatively be adhered together by employing microwave welding or other heat sealing techniques.

The winding duct-formation process is generally similar to that described in patent 773565 (to which reference is here made for further detail).

The substrate material may take any suitable form, for example a polymeric plastics material such as polyester, polypropylene, polyvinyl chloride (PVC) or polyethylene. Alternatively, the strip may comprise a laminated or partially laminated material such as a metal/plastics laminate.

The reinforcement element is typically wire, eg. metal wire, preferably of spring-grade hardness.

In order to periodically sever predetermined lengths of duct, apparatus 100 further includes respective severing or cutting mechanisms 200, 240. Mechanism 200, shown in detail in FIG. 3 incorporates a wire guillotine 202 and is located upstream of winding station 130, actuable to cut the wire 118 before it reaches its laminating position at mandrel 134. Mechanism 240 includes a retractable motorised rotating knife 242 and is located outwardly of the winding station and actuable to sever the helically wound duct into predetermined lengths.

Referring in particular to FIG. 3, wire guillotine 202 is mounted on guillotine table 204 which in turn is supported by four linear bearing blocks 206, capable of traversing in either direction, on a pair of linear rods 208. Rods 208 are fixed to the duct machine chassis (not shown in FIG. 3) via chassis mounting blocks 210. For absorbing the shock of the severance, respective shock absorbing springs 212 are fitted over linear rods 208 between linear bearing blocks 206 and chassis mounting blocks 210.

A further pneumatic device 222 provides forward motion to guillotine table 204 at the instant of shear motion, as further discussed below, and is optional and required only in very high speed machine circumstances. Skilled electronic motion designers will recognise that more sophisticated digital or robotic devices are currently available to control the movements of the apparatus.

Turning now to FIGS. 1, 4 and 5, motorized rotating knife 242 is attached to pneumatic cylinder 244 mounted in turn within vertical support plate 246 having upper and lower support blocks 246a and 246b. The upper and lower support blocks are slidably mounted on a pair of guide rods 256: blocks 246a, 246b are precision machined or contain linear bearings. Upper support block 246a is fitted with ball screw bearing 248 (or simply machined with a female thread) allowing a traversing of the assembly in either direction on motorized threaded drive rod 250 which in turn is rotatably driven by drive motor 252. This sub-assembly of knife and linear threaded drive is in turn supported between the mandrel backing plate 254 and a front plate 260 of the machine chassis by guide rods 256.

In operation, a sequence is triggered, ideally electronic (not shown), by a length of produced flexible duct reaching a measured length. The initial step in the sequence is severance of the wire by actuation of a stroke of wire guillotine 202. The wire behind the guillotine is held stationary within the confine of rear guide tube 218 by operation of pneumatic actuator 217 to cause closure between motor driven wheel 214 and closure wheel 216. As the motor 215 is also now deactivated, the wire is held stationary while the mandrel continues to wind up the other components and thereby continues to produce the duct. The ‘shock’ of the wire severance is absorbed by allowing the guillotine table 204 to move on rods 208 against springs 212 until rest is achieved.

In circumstances where the speed of wire being drawn forward exceeds the normal capability of the wire guillotine 202 to effect severance on a timely basis, pneumatic device 222 may be deployed. This device provides forward thrust to guillotine table 204, synchronous with the instant severance occurs, at a measured speed that allows the guillotine blades to ‘catch’ the wire. Consisting of a high capacity pneumatic cylinder mounted rigidly with its output shaft 223 motivating forward against guillotine table 204 and electronic (or other known) means synchronizing response with the wire guillotine 202, the force (speed) can be modified to correspond with the travel of the wire by adjusting the pressure of air supplied to the device 222. The output shaft 223 returns to the rest position immediately upon completion of the forward stroke, allowing the springs 212 to absorb the ‘shock’ effect as described above.

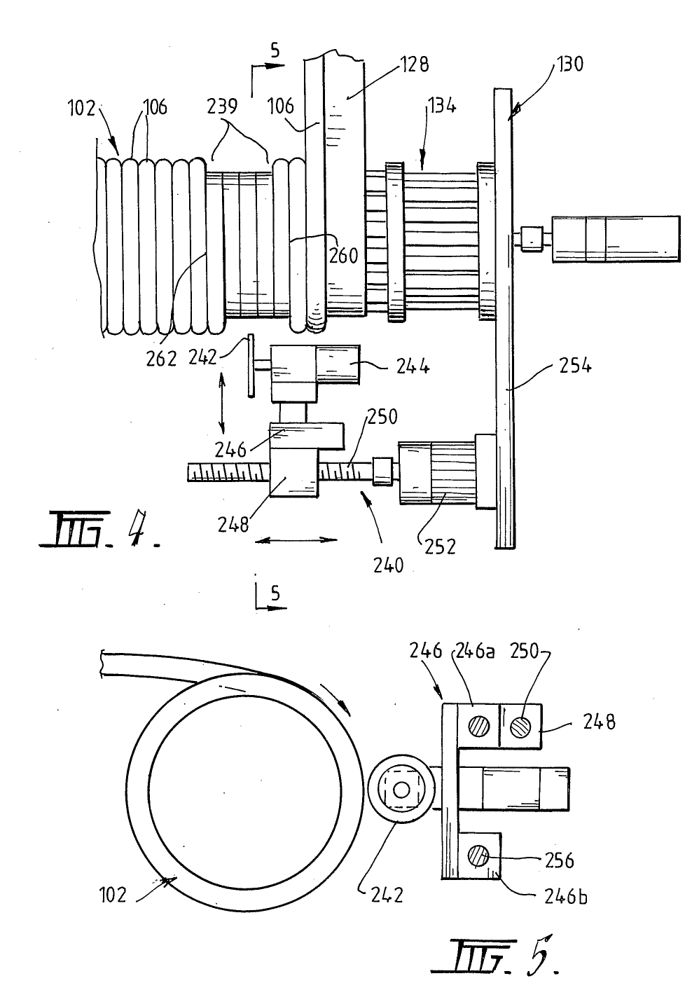

The severance of wire activates a pre-determined delay time period equivalent to the linear travel of several helixes of substrate material. This time period results in a segment 239 (FIG. 4) of wire-free tube formation during which the duct is severed by mechanism 240, without the presence of wire, during the next step of the operational sequence to be described below.

Following this delay period, closure wheel 216 remains engaged and motor driven drive wheel 214 is re-activated. The wire, which is being nipped between the surfaces of drive wheel 214 and closure wheel 216, is driven forward by the wheel pair past the now open blades of wire guillotine 202 into the enlarged mouth 221 of forward guide 220, which directs the wire to re-enter its laminating position within the helixing duct tube. The enlarged mouth 221 of forward guide 220 is designed to provide a larger target area for the incoming wire edge. The motor driven drive wheel is electronically controlled (via machine computer, digitally or with analog interface) to synchronize the wire re-entry speed with the linear travel speed of the substrate material.

After severing wire 118, which is normally drawn by the mandrel, wire 118 passes between motor driven drive wheel 214 and normally open closure wheel 216, then through rear guide tube 218 and the (normally open) guillotine 202 and on towards the mandrel 134 via re-entry guide 220. Wire 118 is driven linearly forwardly by a motor 215 that rotates wheel 214. Wheel 216 can be selectively closed against wheel 214 by a pneumatic actuator 217. The wheels are both fitted with rolling surface treatment, such as hard rubber or polyurethane, to provide good grip.

When the wire re-enters the laminating and helixing motion of the tube formation, a magnetic trigger mechanism or similar electronic trigger device (not shown) allows the closure wheel 216 to open and simultaneously power motor 217 to disengage drive wheel 214, since the wire will now be drawn forward by the winding mandrel. This sequence of the process is now complete and the wire cutting sub-assembly 200 stands ready to respond to signalling for the next length.

The preferred method of triggering the duct severance mechanism 240 is a pre-programmed electronic digital component which can calculate the delay in the re-entry of wire to allow for a given number of helixes defining the duct wire gap, and is capable of responding to diameter and helix distance inputs. The two spaced ends of wire 218 defining the gap are indicated at 260, 262 in FIG. 4. Following initiation, which is the registration of the mid-point between wire ends 260, 262, the duct cutting motorized blade 242 is energized, triggering energy to threaded roller drive motor 252, which is speed controlled to drive forward the motorized blade 242 and associated sub-assembly, at an identical speed to the forward lineal progress of the helically forming flexible duct.

Pneumatic cylinder 244 is then triggered to push forward the duct cutting motorized blade 242 onto the surface of the duct, thereby effecting severance as at least one complete revolution of the duct occurs. Ideally, the length of travel available on the threaded roller drive 250 is sufficient for the motorized cutting blade to follow the cutting action path for two or more revolutions of the duct before the pneumatic cylinder 244 is triggered to allow the cutting blade 242 to retract to its rest position. In turn, retraction of the pneumatic cylinder 244 triggers a reversing mode in the threaded roller drive motor 252 which cancels when the duct cutting motorized blade 242 returns to its rest position.

For convenience and longevity, the cutting knife disc portion of duct cutting motorized blade may be coated with Teflon (PTFE) or similar non-stick material to prevent any accumulation of adhesive material on or around the cutting edge. Those skilled in the severance of polymer materials will be familiar with alternative means such as superheated air or burnt gas “Knives” et al for severing the segment of duct without the wire.

With severance of the duct portion now complete, the finished length of duct may be removed from the run-off portion of the machine by automated ejection means, or manually, allowing the incoming length to proceed.

1. An apparatus for manufacturing a tubular product, comprising:
a winding station for winding a substrate component and a reinforcement element in a helical path to form a reinforced tubular product;
respective means for feeding said elongate substrate component and said elongate reinforcement element to said winding station;
first severing means for cutting the reinforcement element upstream of the winding station;
means for withholding delivery of the reinforcement element upstream of the cut for a predetermined time period that results in a segment of the tubular product without the reinforcement element; and
second severing means for severing the tubular product within said segment to provide said predetermined length of the tubular product.

2. The apparatus according to claim 1, further including control means for activating said first severing means and said withholding means so as to cut the reinforcement element upstream of the winding station and withhold delivery of the reinforcement element upstream of the cut for a predetermined time period that results in said segment of the tubular product without the reinforcement element, said control means then activating said second severing means to sever the tubular product within said segment whereby to provide said predetermined length of the tubular product.

3. The apparatus according to claim 1, wherein the tubular product is a duct.

4. The apparatus according to claim 3, wherein said elongate substrate component is a strip of flexible substrate material that in the duct forms a helically wound rounded portion that encapsulates a solid core of insulating material and wherein the helically wound reinforcement element is encapsulated by the strip of flexible substrate material in the tubular duct.

5. The apparatus according to claim 1, wherein the first severing means comprises a wire guillotine.

6. Apparatus The apparatus according to claim 5, wherein the wire guillotine is mounted for sliding movement parallel to the wire.

7. The apparatus according to claim 1, wherein the first severing means includes means to absorb the reaction force of the wire severance.

8. The apparatus according to claim 1, wherein the second severing means comprises a knife.

9. The apparatus according to claim 1, wherein the second severing means comprises a high temperature cutting device that severs the duct by melting or evaporation of the substrate component in an annular zone of the duct with said segment.

10. The apparatus according to claim 1, wherein the reinforcement element is wire.

11. The apparatus according to claim 1, wherein said predetermined time period is the time for the winding station to form four to eight windings.

12. A method of manufacturing a reinforced tubular product, including the steps of:
feeding an elongate substrate component and an elongate reinforcement element to a winding station;
winding the substrate component and the reinforcement element at the winding station in a helical path to form a reinforced tubular product; and
severing a predetermined length of the tubular product by cutting the reinforcement element upstream of the winding station and withholding delivery of the reinforcement element upstream of the cut for a predetermined time period that results in a segment of the tubular product without the reinforcement element, and then severing the tubular product within said segment whereby to provide said predetermined length of the tubular product.

13. The method according to claim 12, wherein the tubular product is a duct.

14. The method according to claim 13, wherein said elongate substrate component is a strip of flexible substrate material that in the duct forms a helically wound rounded portion that encapsulates a solid core of insulating material and wherein the helically wound reinforcement element is encapsulated by the strip of flexible substrate material in the tubular duct.

15. The method according to claim 12, wherein the reinforcement is wire.

16. The method according to claim 12, wherein said predetermined time period is the time for the winding station to form four to eight windings.
